(19) United States
(12) Patent Application Publication
(10) Pub. No.: US 2025/0322545 A1
(43) Pub. Date: Oct. 16, 2025

(54) CONTENT-SPECIFIC FIDELITY METRICS FOR IMAGE COMPRESSION BASED ON SEMANTIC SEGMENTATION MODELS

(71) Applicant: Synaptics Incorporated, San Jose, CA (US)

(72) Inventor: Karol Trojanowski, Bielsko-Biala (PL)

(73) Assignee: Synaptics Incorporated, San Jose, CA (US)

(21) Appl. No.: 18/634,316

(22) Filed: Apr. 12, 2024

(51) Int. Cl. G06T 9/00; G06T 7/10

(52) U.S. Cl. CPC G06T 9/00; G06T 7/10; G06T 2207/30168

(57) ABSTRACT

This disclosure provides methods, devices, and systems for image compression. The present implementations more specifically relate to systems and techniques for selecting an image compression scheme for a given type of content or application. An image encoder may encode an image based on an image compression scheme. In some aspects, the image encoder may infer first and second segmentation masks from the original image and the encoded image, respectively, based a machine learning model. The machine learning model may be trained to extract one or more types of content from input images so that the segmentation masks include only the extracted content (and exclude any other types of content) from the images. The image encoder may further calculate a visual fidelity metric for the encoded image based on the masks and selectively transmit the encoded image over a communication channel based at least in part on the visual fidelity metric.

### TECHNICAL FIELD

The present implementations relate generally to image compression, and specifically to content-specific fidelity metrics for image compression based on semantic segmentation models.

### BACKGROUND OF RELATED ART

A digital image can be represented by an array of pixel values (or multiple arrays of pixel values associated with different channels) that can be displayed or otherwise rendered on an electronic display device (such as a computer, smartphone, or television, among other examples). A digital video is a sequence of digital images (or “frames”) that can be displayed or otherwise rendered in succession. Some electronic display devices may receive digital image(s), over a communication channel (such as a wired or wireless medium), from a source device (such as an image capture device or data repository). Due to bandwidth limitations of the communication channel, digital image data is often encoded or compressed prior to transmission from the source device. Data compression is a technique for encoding information into smaller units of data. The encoded image data is subsequently decoded by the display device to recover the corresponding digital image. As such, data compression can reduce the bandwidth or overhead needed to store or transmit digital images over the communication channel.

Data compression techniques can be generally categorized as “lossy” or “lossless.” Lossless data compression does not result in any loss of information between the encoding step and the decoding step, as long as the communication channel does not introduce errors into the encoded data. As a result, the decoded image is identical (or substantially identical) to the original image prior to encoding. Example lossless compression techniques include entropy encoding (such as arithmetic coding, Huffman coding, or Golomb coding) and run-length encoding (RLE), among other examples. By contrast, lossy data compression may result in some loss of information between the encoding step and the decoding step. As a result, the decoded image may have a lower image quality than the original image prior to encoding. Example lossy compression techniques include transform coding (such as through application of a spatial-frequency transform) and quantization (such as through application of a quantization matrix), among other examples.

Different lossy compression techniques may be better suited for encoding different types of image content. For example, some compression techniques may preserve greater detail or visual fidelity in text or geometric shapes (also referred to as “screen content”) compared to other content in a digital image. To determine the suitability of any lossy compression techniques for a given application, the image quality of the compressed image and the original image can be compared using various visual fidelity metrics. Example suitable visual fidelity metrics include peak signal-to-noise ratio (PSNR), PSNR based on properties of the human visual system (PSNR-HVS), PSNR-HVS with visual masking (PSNR-HVS-M), video multimethod assessment fusion (VMAF), and learned perceptual image patch similarity (LPIPS), among other examples. However, as applied to digital images, such visual fidelity metrics merely indicate a general visual fidelity of the image (as a whole). Thus, new image analysis techniques are needed to assess the visual fidelity of specific types of content, to the exclusion of other types of content, in a digital image.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of image compression. The method includes steps of receiving an image for transmission over a communication channel; encoding the image as a first encoded image based on a first image compression scheme; inferring a first segmentation mask from the image based on a first machine learning model; inferring a second segmentation mask from the first encoded image based on the first machine learning model; calculating a first visual fidelity metric for the first encoded image based on the first segmentation mask and the second segmentation mask; and selectively transmitting the first encoded image over the communication channel based at least in part on the first visual fidelity metric.

Another innovative aspect of the subject matter of this disclosure can be implemented in an image encoder that includes a processing system and a memory. The memory stores instructions that, when executed by the processing system, cause the image encoder to receive an image for transmission over a communication channel; encode the image as a first encoded image based on a first image compression scheme; infer a first segmentation mask from the image based on a first machine learning model; infer a second segmentation mask from the first encoded image based on the first machine learning model; calculate a first visual fidelity metric for the first encoded image based on the first segmentation mask and the second segmentation mask; and selectively transmit the first encoded image over the communication channel based at least in part on the first visual fidelity metric.

Another innovative aspect of the subject matter of this disclosure can be implemented in a method of image compression. The method includes steps of generating an input image that includes content overlaying other media; generating a segmentation mask based on the content included in the input image; and training the neural network to reproduce the segmentation mask based on the input image.

### BRIEF DESCRIPTION OF THE DRAWINGS

The present implementations are illustrated by way of example and are not intended to be limited by the figures of the accompanying drawings.

FIG. 1 shows an example communication system for encoding and decoding data.

FIG. 2 shows a block diagram of an example image encoding system, according to some implementations.

FIG. 3 shows a block diagram of an example content extractor for digital images, according to some implementations.

FIG. 4 shows a block diagram of an example machine learning system, according to some implementations.

FIG. 5 shows a block diagram of an example image encoder, according to some implementations.

FIG. 6 shows an illustrative flowchart depicting an example operation for image compression, according to some implementations.

FIG. 7 shows an illustrative flowchart depicting an example operation for training a neural network, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, different lossy compression techniques may be better suited for encoding different types of image content. For example, some compression techniques may preserve greater detail or visual fidelity in text or geometric shapes (also referred to as “screen content”) compared to other content in a digital image. To determine the suitability of any lossy compression techniques for a given application, the image quality of the compressed image and the original image can be compared using various visual fidelity metrics. Example suitable visual fidelity metrics include peak signal-to-noise ratio (PSNR), PSNR based on properties of the human visual system (PSNR-HVS), PSNR-HVS with visual masking (PSNR-HVS-M), video multimethod assessment fusion (VMAF), and learned perceptual image patch similarity (LPIPS), among other examples. However, as applied to digital images, such visual fidelity metrics merely indicate a general visual fidelity of the image (as a whole). Aspects of the present disclosure recognize that machine learning models can be trained to extract specific types of content, to the exclusion of other types of content, from a digital image.

Machine learning is a technique for improving the ability of a computer system or application to perform a specific task. During a training phase, a machine learning system is provided with multiple “answers” and a large volume of raw input data. The machine learning system analyzes the input data to learn a set of rules (also referred to as the “machine learning model”) that can be used to map the input data to the answers. During an inferencing phase, the machine learning system uses the trained machine learning model to infer answers from new input data. By training a machine learning model to infer (or “extract”) only one or more types of content from a digital image, aspects of the present disclosure may use existing visual fidelity metrics to compare the content extracted from a compressed image with the content extracted from the original image. Thus, the resulting visual fidelity metrics may indicate how well an image compression scheme preserves the visual fidelity of a particular type of image content (such as screen content).

Various aspects relate generally to image compression, and more particularly, to systems and techniques for selecting an image compression scheme for a given type of content or application. An image encoder may receive an image for transmission over a communication channel and encode the image based on an image compression scheme. In some aspects, the image encoder may infer first and second segmentation masks from the original image and the encoded image, respectively, based a machine learning model. In some implementations, the machine learning model may be trained to extract one or more types of content from input images so that the segmentation masks include only the extracted content (and exclude any other types of content) from the images. The image encoder may further calculate a visual fidelity metric for the encoded image based on the first and second segmentation masks and selectively transmit the encoded image over the communication channel based at least in part on the visual fidelity metric. In some implementations, the image encoder may repeat this process using different image compression techniques and transmit an encoded image having the highest visual fidelity metric.

Particular implementations of the subject matter described in this disclosure can be implemented to realize one or more of the following potential advantages. By training machine learning models to generate segmentation masks that include only particular types of content from input images, aspects of the present disclosure may assess how well image compression schemes preserve the visual fidelity of such content in digital images. For example, by calculating visual fidelity metrics on segmentation masks (rather than digital images), the resulting visual fidelity metrics may indicate the image quality of a desired type of content, to the exclusion of any other types of content, in the compressed images (rather than the general image quality of the compressed image, as a whole). Accordingly, an image encoder may dynamically select an optimal image compression scheme (among any available image compression schemes) for any given application or image content type.

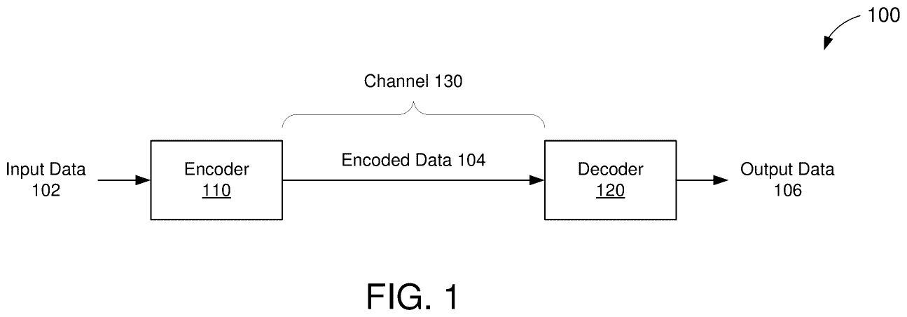

FIG. 1 shows an example communication system 100 for encoding and decoding data. The communication system 100 includes an encoder 110 and a decoder 120. In some implementations, the encoder 110 and decoder 120 may be provided in respective communication devices such as, for example, computers, switches, routers, hubs, gateways, cameras, displays, or other devices capable of transmitting or receiving communication signals. In some other implementations, the encoder 110 and decoder 120 may be included in the same device or system.

The encoder 110 receives input data 102 to be transmitted or stored via a channel 130. For example, the channel 130 may include a wired or wireless communication medium that facilities communications between the encoder 110 and the decoder 120. Alternatively, or in addition, the channel 130 may include a data storage medium. In some aspects, the encoder 110 may be configured to compress the size of the input data 102 to accommodate the bandwidth, storage, or other resource limitations associated with the channel 130. For example, the encoder 110 may encode each unit of input data 102 as a respective “codeword” that can be transmitted or stored over the channel 130 (as encoded data 104). The decoder 120 is configured to receive the encoded data 104, via the channel 130, and decode the encoded data 104 as output data 106. For example, the decoder 120 may decompress or otherwise reverse the compression performed by the encoder 110 so that the output data 106 is substantially similar, if not identical, to the original input data 102.

Data compression techniques can be generally categorized as “lossy” or “lossless.” Lossless data compression does not result in any loss of information between the encoding and decoding steps as long as the channel 130 does not introduce errors into the encoded data 104. As a result, the output data 106 is identical (or substantially identical) to the input data 102. Example lossless compression techniques include entropy encoding (such as arithmetic coding, Huffman coding, or Golomb coding) and run-length encoding (RLE), among other examples. By contrast, lossy data compression may result in some loss of information between the encoding and decoding steps. As a result, the output data 106 may be different than the input data 102. Example lossy compression techniques include transform coding (such as through application of a spatial-frequency transform) and quantization (such as through application of a quantization matrix), among other examples.

Different lossy compression techniques may be better suited for encoding different types of input data 102. For example, digital images are often encoded using lossy compression techniques that preserve the visual fidelity of certain aspects of the image (such as text or other “screen content” representing important information) while sacrificing the visual fidelity of other aspects of the image (such as background content or visuals intended to fill empty space). Thus, the optimal encoding or compression scheme for any given application may depend on the type of content to be prioritized for the application. In some aspects, the encoder 110 may select a lossy compression scheme to be used for encoding the input data 102 based, at least in part, on the type of content to be prioritized in the input data 102. For example, the encoder 110 may compare the performance of various lossy compression schemes with respect to preserving a particular type of content in the input data 102 and select the compression scheme that yields the greatest performance.

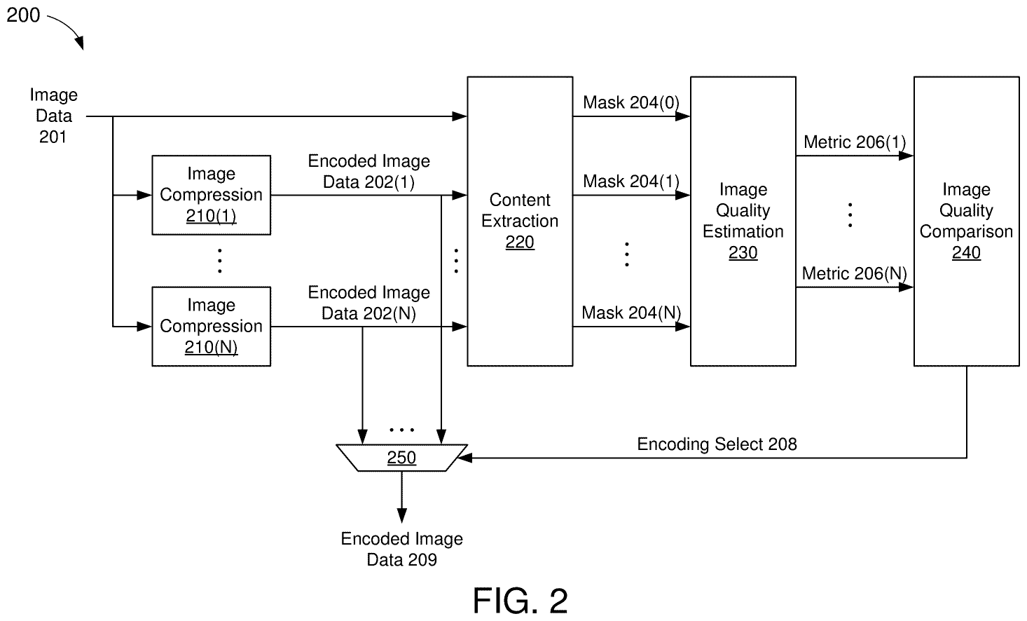

FIG. 2 shows a block diagram of an example image encoding system 200, according to some implementations. The image encoding system 200 is configured to encode image data 201 as encoded image data 209. The image data 201 may include an array of pixel values (or multiple arrays of pixel values associated with different color channels) representing a digital image or frame of video captured or acquired by an image source (such as a camera or other image output device). In some implementations, the image encoding system 200 may be one example of the encoder 110 of FIG. 1. With reference to FIG. 1, the image data 201 may be one example of the input data 102 and the encoded image data 209 may be one example of the encoded data 104.

The image encoding system 200 includes a number (N) of image compression components 210(1)-210(N), a content extraction component 220, an image quality estimation component 230, and an image quality comparison component 240. The image compression components 210(1)-210(N) are configured to encode the image data 201 as encoded image data 202(1)-202 (N), respectively, according to one or more image compression schemes. In some implementations, each of the image compression components 210(1)-210 (N) may implement a respective lossy compression scheme. As described with reference to FIG. 1, different lossy compression techniques may be better at preserving the visual fidelity of different types of content associated with the input image data 201. For example, screen content (such as text, geometric shapes, or icons) may have different levels of detail or image quality in the encoded image data 202(1) compared to the encoded image data 202(N).

The content extraction component 220 is configured to extract one or more types of content from the image data 201 and the encoded image data 202(1)-202(N). In some implementations, the content extraction component 220 may produce a segmentation mask 204(0) (also referred to as a “reference mask”) that includes only the particular type(s) of content extracted from the image data 201 (excluding all other types of content from the image data 201) and may produce segmentation masks 204(1)-204(N) that include only the particular type(s) of content extracted from the encoded image data 202(1)-202 (N), respectively. In some implementations, each of the segmentation masks 204(0)-204(N) may include only screen content from the image data 201 and the encoded image data 202(1)-202(N). Because different lossy compression techniques are used to generate the encoded image data 202(1)-202 (N), each of the segmentation masks 204(1)-204(N) may have a different level of visual fidelity or image quality.

In some implementations, each of the segmentation masks 204(0)-204(N) may indicate an opacity of the content extracted from the corresponding image data (such as the image data 201 and the encoded image data 202(1)-202(N)). This may ensure that the edges of the content can be more accurately reproduced to provide a more pleasing viewing experience (particularly for text-based content). For example, the reference mask 204(0) may be an 8-bit (floating-point or integer) mask which indicates a degree or amount of the particular content type included in each pixel of the image data 201 (such as on a scale of 256 values). Similarly, each of the segmentation masks 204(1)-204(N) also may be an 8-bit mask indicating a degree or amount of the particular content type included in each pixel of the encoded image data 202(1)-202(N), respectively.

The image quality estimation component 230 is configured to compare each of the segmentation masks 204(1)-204(N) to the reference mask 204(0) and calculate visual fidelity metrics 206(1)-206(N) indicating the visual fidelity of the segmentation masks 204(1)-204(N), respectively. In some implementations, the image quality estimation component 230 may calculate the visual fidelity metrics 206(1)-206(N) using any known visual fidelity or image quality estimation techniques. Example suitable visual fidelity metrics include PSNR, PSNR-HVS, PSNR-HVS-M, VMAF, and LPIPS, among other examples. In some other implementations, the image quality estimation component 230 may use the segmentation masks 204(0)-204(N) as weights to be applied to other types of metrics. For example, the image quality estimation component 230 may compute the weighted differences, or a convolution of intermediate weights, between the segmentation masks 204(0)-204(N). Accordingly, the visual fidelity metrics 206(1)-206(N) may indicate how well each of the image compression components 210(1)-210(N) preserves the visual fidelity of particular type(s) of content in the image data 201.

The image quality comparison component 240 is configured to compare the visual fidelity metrics 206(1)-206(N) and select one of the image compression components 210(1)-210(N) to be used for a given application based, at least in part, on the comparison. For example, the image quality comparison component 240 may produce an encoding select signal 208 indicating the selected image compression component (or scheme). In some implementations, the image quality comparison component 240 may select the image compression component (or scheme) associated with the highest visual fidelity metric (or the visual fidelity metric indicating the highest image quality) among the visual fidelity metrics 206(1)-206(N). For example, if the visual fidelity metric 206(1) is associated with the highest image quality among the visual fidelity metrics 206(1)-206(N), the encoding select signal 208 may indicate the image compression component 210(1).

In some implementations, the encoding select signal 208 may be provided as a selection input to a multiplexer 250 configured to output one of the sets of encoded image data 202(1)-202(N) as the encoded image data 209. For example, if the encoding select signal 208 indicates the image compression component 210(1), the multiplexer 250 may output the encoded image data 202(1) as the encoded image data 209. Accordingly, the image encoding system 200 may output encoded image data 209 that is optimized for any given application or content type.

In some aspects, the image encoding system 200 may transmit the encoded image data 209 to an image decoder (such as the decoder 120) over a communication channel (such as the channel 130). The image decoder may decode the encoded image data 209 to reproduce the digital image on a display device (such as a television, computer monitor, smartphone, or any other device that includes an electronic display). As described with reference to FIG. 1, the image decoder may reverse the encoding performed by the image encoding system 200 to recover a digital image represented by the original image data 201. In some implementations, the image encoding system 200 may transmit a sequence of frames of encoded image data 209 each representing a respective image or frame of a digital video so that the image decoder may display or render the digital video on the display device.

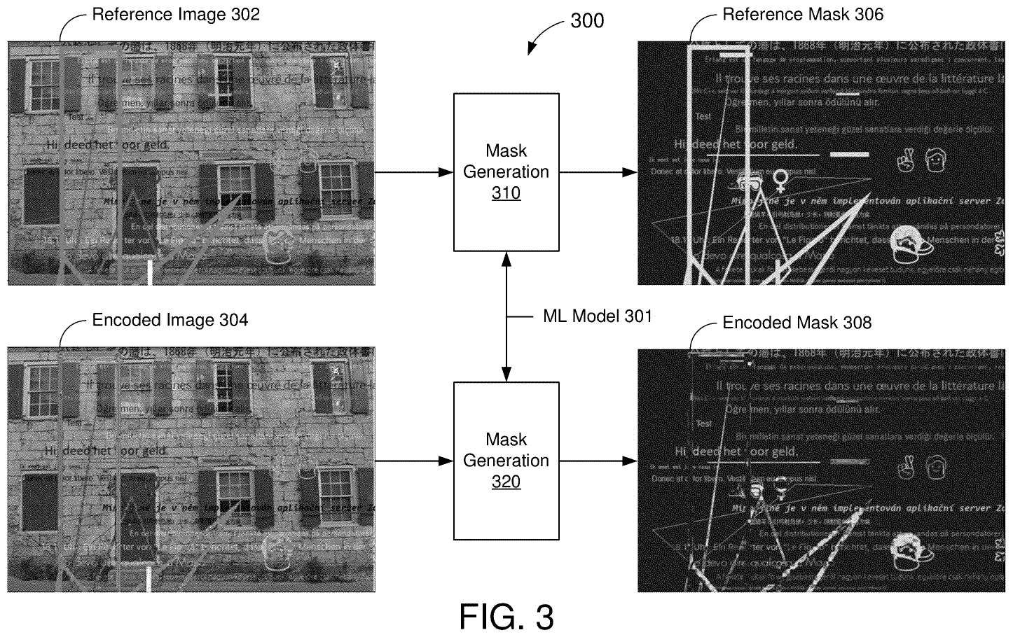

FIG. 3 shows a block diagram of an example content extractor 300 for digital images, according to some implementations. The content extractor 300 is configured to receive a reference image 302 and an encoded image 304 and generate a reference mask 306 and an encoded mask 308 based on the images 302 and 304, respectively.

In some implementations, the content extractor 300 may be one example of the content extraction component 220 of FIG. 2. With reference to FIG. 2, the reference image 302 may be one example of the image data 201 and the reference mask 306 may be one example of the segmentation mask 204(0), whereas the encoded image 304 may be one example of any of the encoded image data 202(1)-202(N) and the encoded mask 308 may be one example of any of the segmentation masks 204(1)-204(N). Although only one encoded image is shown (for simplicity), the content extractor 300 may receive any number (N) of encoded images as inputs in actual implementations (such as described with reference to FIG. 2).

The content extractor 300 includes a first mask generation component 310 and a second mask generation component 320. The first mask generation component 310 is configured to extract one or more types of content from the reference image 302 to produce the reference mask 306. The second mask generation component 320 is configured to extract one or more types of content from the encoded image 304 to produce the encoded mask 308. In the example of FIG. 3, each of the mask generation components 310 and 320 is configured to extract screen content from the reference image 302 and the encoded image 304, respectively. In some implementations, each of the masks 306 and 308 may be an 8-bit (floating-point or integer) mask indicating an opacity of the content extracted from the images 302 and 304, respectively (such as described with reference to FIG. 2).

As shown in FIG. 3, the reference mask 306 includes only the text, geometric shapes, and icons that are overlaid upon other media in the reference image 302 (such as an image of a building). More specifically, each pixel of the reference mask 306 maps to a respective pixel of the reference image 302 (but each pixel of the reference image 302 does not map to a respective pixel of the reference mask 306). Similarly, the encoded mask 308 includes only the text, geometric shapes, and icons that are overlaid upon other media in the encoded image 304 (such as an image of a building). More specifically, each pixel of the encoded mask 308 maps to a respective pixel of the encoded image 304 (but each pixel of the encoded image 304 does not map to a respective pixel of the encoded mask 308).

Aspects of the present disclosure recognize that machine learning models can be trained to extract specific types of content, to the exclusion of other types of content, from a digital image. Machine learning is a technique for improving the ability of a computer system or application to perform a specific task. During a training phase, a machine learning system is provided with multiple “answers” and a large volume of raw input data. The machine learning system analyzes the input data to learn a set of rules (also referred to as the “machine learning model”) that can be used to map the input data to the answers. During an inferencing phase, the machine learning system uses the trained machine learning model to infer answers from new input data.

In some aspects, the mask generation components 310 and 320 may extract the content of the segmentation masks 306 and 308 from the images 302 and 304, respectively, based on a machine learning (ML) model 301. By using the same ML model 301 to infer (or “extract”) one or more types of content (such as screen content) from each of the images 302 and 304, aspects of the present disclosure may use existing visual fidelity metrics to compare the content extracted from encoded image 304 with the content extracted from the reference image 302 (such as described with reference to FIG. 2). Thus, the resulting visual fidelity metrics may indicate how well an image compression scheme preserves the visual fidelity of a particular type of image content (such as screen content).

In some aspects, the ML model 301 may extract multiple types of content from the images 302 and 304. In some implementations, a single ML model 301 may be trained to infer multiple segmentation masks from a single input image. For example, each of the segmentation masks may include a different type of content (such as text, geometry, or icons) extracted from the same input image. In some other implementations, multiple ML models may be used to extract different types of content from the images 302 and 304. For example, a first ML model may be trained to infer a segmentation mask that only includes text, a second ML model may be trained to infer a segmentation mask that only includes geometric shapes, and a third ML model may be trained to infer a segmentation mask that only includes icons. Generating multiple segmentation masks for each of the images 302 and 304 allows for much finer granularity of visual fidelity estimation.

As described with reference to FIG. 2, an image quality estimation component (such as the image quality estimation component 230) may compare the encoded mask 308 with the reference mask 306 and calculate a visual fidelity metric (such as any of the visual fidelity metrics 206(1)-206(N)) indicating the visual fidelity of screen content in the encoded image 304. As shown in FIG. 3, the screen content in the encoded mask 308 appears grainy, blurry, broken, and faded compared the screen content in the reference mask 306. Accordingly, the lossy compression scheme used to produce the encoded image 304 may be poorly suited for the current application or content type.

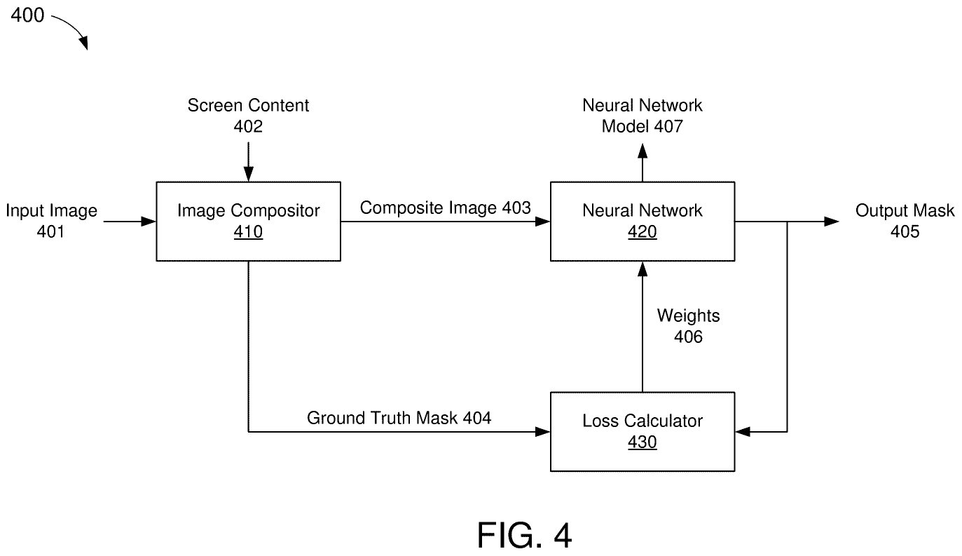

FIG. 4 shows a block diagram of an example machine learning system 400, according to some implementations. The machine learning system 400 is configured to produce a neural network model 407 based, at least in part, on a number of input images 401 and screen content 402 to be extracted from the input images 401. In some implementations, the neural network model 407 may be one example of the ML model 301 of FIG. 3. Thus, the neural network model 407 may include a set of rules that can be used to infer or extract screen content from an input image (such as any of the images 302 or 304).

The machine learning system 400 includes an image compositor 410, a neural network 420, and a loss calculator 430. The image compositor 410 is configured to combine the screen content 402 with the input image 401 to produce a composite image 403 (similar to the reference image 302). The screen content 402 may include pre-generated text, geometry, icons, or other content for which visual fidelity is to be measured. In some implementations, the image compositor 410 may overlay the screen content 402 on the input image 401 using any known image compositing techniques. The image compositor 410 also produces a ground truth mask 404 based on the screen content 402 and the input image 401. The ground truth mask 404 includes only the screen content 402 from the composite image 403 (similar to the reference mask 306). In some implementations, the image compositor 410 may derive the ground truth mask 404 from an alpha channel of the composite image 403. For example, the ground truth mask 404 may be a single-channel floating point mask having the same size or dimensions as the composite image 403.

In some implementations, the machine learning system 300 may train the neural network 420 to reproduce the ground truth mask 404 based on the composite image 403. Deep learning is a particular form of machine learning in which the inferencing and training phases are performed over multiple layers. Deep learning architectures are often referred to as “artificial neural networks” due to the manner in which information is processed (similar to a biological nervous system). For example, each layer of an artificial neural network may be composed of one or more “neurons.” Each layer of neurons may perform a different transformation on the output data from a preceding layer so that the final output of the neural network results in the desired inferences. The set of transformations associated with the various layers of the network is referred to as a “neural network model.” Example suitable neural networks include convolutional neural networks (CNNs) and recurrent neural networks (RNN), among other examples.

The neural network 420 receives the composite image 403 and attempts to recreate the ground truth mask 404. For example, the neural network 420 may form a network of connections across multiple layers of artificial neurons that begin with the composite image 403 and lead to an output mask 405. The connections are weighted to result in an output mask 405 that closely resembles the ground truth mask 404. The training operation may be performed over multiple iterations. In each iteration, the neural network 420 produces an output mask 405 based on the weighted connections across the layers of artificial neurons, and the loss calculator 430 updates the weights 406 associated with the connections based on an amount of loss (or error) between the output mask 405 and the ground truth mask 404. The neural network 420 may output the weighted connections as the neural network model 407 when certain convergence criteria are met (such as when the loss falls below a threshold level or after a predetermined number of training iterations).

In some implementations, the neural network model 407 may be trained to produce multiple output masks 405 for multiple types of screen content 402 (or multiple color channels for each type of screen content 402). In other words, the neural network model 407 may be trained to segment different types of content concurrently. For example, the neural network model 407 may produce a different output mask 405 for each of text, geometric shapes, and icons. In such implementations, the image compositor 410 may produce a respective ground truth mask 404 for each type of screen content 402 to be represented in a different output mask 405. As described with reference to FIG. 3, generating multiple segmentation masks for an input image allows for much finer granularity of visual fidelity estimation.

In some other implementations, the machine learning system 400 may be configured to train multiple neural network models 407 for multiple types of screen content 402 (or multiple color channels for each type of screen content 402). For example, the machine learning system 400 may repeat the training operation described above for different types of screen content 402 so that a different neural network model 407 is generated for each type of screen content 402. Training a neural network model 407 to differentiate among various types of screen content 402 improves the accuracy of the segmentation mask inferred by the neural network model 407. For example, training a neural network model 407 to extract text, while excluding geometric shapes and icons, from a composite image 403 improves the accuracy of the neural network model 407 for text extraction.

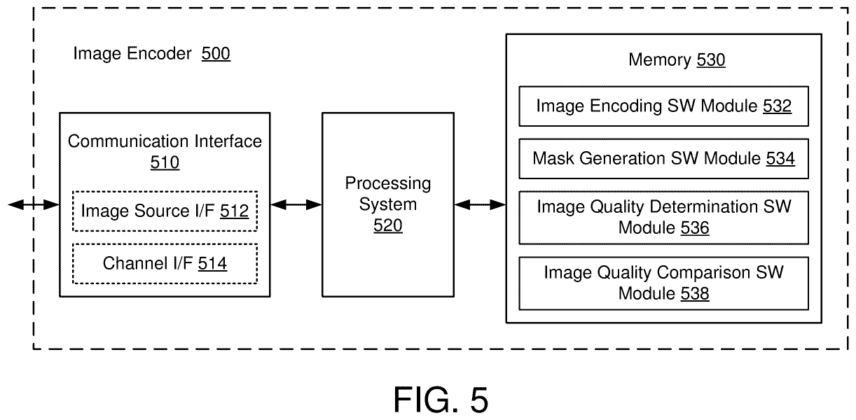

FIG. 5 shows a block diagram of an example image encoder 500, according to some implementations. In some implementations, the image encoder 500 may be one example of the image encoding system 200 of FIG. 2. More specifically, the image encoder 500 may be configured to encode image data for transmission over a communication channel.

The image encoder 500 includes a communication interface 510, a processing system 520, and a memory 530. The communication interface 510 is configured to receive image data from an image source and transmit encoded image data over the communication channel. In some aspects, the communication interface 510 may include an image source interface (I/F) 512 for communicating with the image source and a channel interface 514 for communicating over the communication channel. In some implementations, the image source interface 512 may receive an image for transmission (such as to be transmitted) over the communication channel.

The memory 530 may include a non-transitory computer-readable medium (including one or more nonvolatile memory elements, such as EPROM, EEPROM, Flash memory, a hard drive, and the like) that may store at least the following software (SW) modules:
an image encoding SW module 532 to encode the image as a first encoded image based on a first image compression scheme;
a mask generation SW module 534 to infer a first segmentation mask from the image based on a first machine learning model and to infer a second segmentation mask from the first encoded image based on the first machine learning model;
an image quality determination SW module 536 to calculate a first visual fidelity metric for the first encoded image based on the first segmentation mask and the second segmentation mask; and
an image quality comparison SW module 538 to selectively transmit the first encoded image over the communication channel based at least in part on the first visual fidelity metric.
   Each software module includes instructions that, when executed by the processing system 520, causes the image encoder 500 to perform the corresponding functions.

The processing system 520 may include any suitable one or more processors capable of executing scripts or instructions of one or more software programs stored in the image encoder 500 (such as in the memory 530). For example, the processing system 520 may execute the image encoding SW module 532 to encode the image as a first encoded image based on a first image compression scheme. The processing system 520 may execute the mask generation SW module 534 to infer a first segmentation mask from the image based on a first machine learning model and to infer a second segmentation mask from the first encoded image based on the first machine learning model. The processing system 520 may execute the image quality determination SW module 536 to calculate a first visual fidelity metric for the first encoded image based on the first segmentation mask and the second segmentation mask. The processing system 520 may further execute the image quality comparison SW module 538 to selectively transmit the first encoded image over the communication channel based at least in part on the first visual fidelity metric.

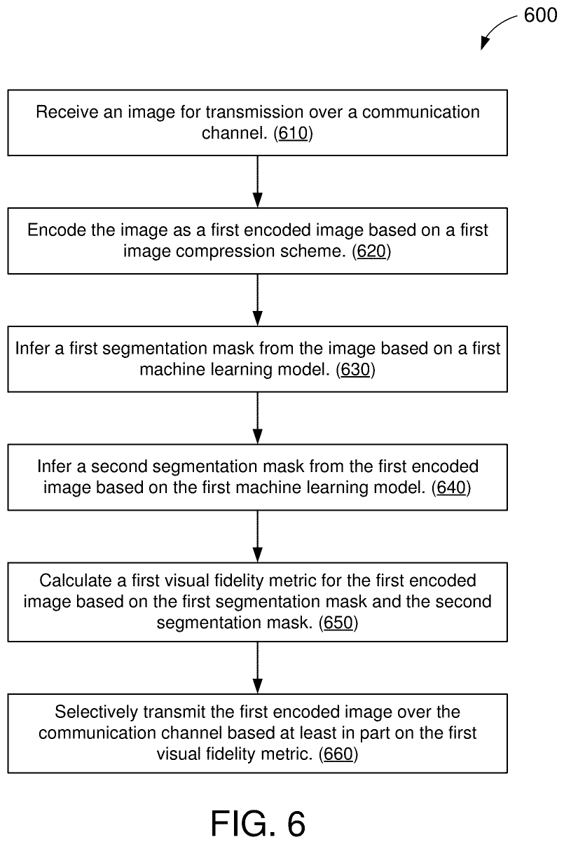

FIG. 6 shows an illustrative flowchart depicting an example operation 600 for image compression, according to some implementations. In some implementations, the example operation 600 may be performed by an image encoder such as the image encoding system 200 of FIG. 2 or the image encoder 500 of FIG. 5.

The image encoder receives an image for transmission over a communication channel (610). The image encoder encodes the image as a first encoded image based on a first image compression scheme (620). The image encoder infers a first segmentation mask from the image based on a first machine learning model (630). The image encoder also infers a second segmentation mask from the first encoded image based on the first machine learning model (640). The image encoder calculates a first visual fidelity metric for the first encoded image based on the first segmentation mask and the second segmentation mask (650). In some implementations, the first visual fidelity metric may include a PSNR, a PSNR-HVS, a PSNR-HVS-M, a VMAF metric, or an LPIPS metric. The image encoder selectively transmits the first encoded image over the communication channel based at least in part on the first visual fidelity metric (660).

In some aspects, the image encoder may further encode the image as a second encoded image based on a second image compression scheme different than the first image compression scheme; infer a third segmentation mask from the second encoded image based on the first machine learning model; calculate a second visual fidelity metric for the second encoded image based on the first segmentation mask and the third segmentation mask; and determine whether the first visual fidelity metric or the second visual fidelity metric indicates a higher image quality, where the first encoded image is selectively transmitted over the communication channel based at least in part on whether the first visual fidelity metric or the second visual fidelity metric indicates a higher image quality.

In some implementations, the selective transmitting of the first encoded image may include refraining from transmitting the first encoded image over the communication channel responsive to determining that the second visual fidelity metric indicates a higher image quality. In some implementations, the image encoder may further transmit the second encoded image, in lieu of the first encoded image, over the communication channel responsive to determining that the second visual fidelity metric indicates a higher image quality.

In some aspects, the first machine learning model may be trained to extract a first type of content from one or more input images. In some implementations, the first type of content may include screen content. In some implementations, the first type of content may include text, geometric shapes, or icons.

In some aspects, the image encoder may further infer a third segmentation mask from the image based on a second machine learning model different than the first machine learning model; infer a fourth segmentation mask from the first encoded image based on the second machine learning model; and calculate a second visual fidelity metric for the first encoded image based on the third segmentation mask and the fourth segmentation mask, where the first encoded image is selectively transmitted over the communication channel based on the first visual fidelity metric and the second visual fidelity metric. In some implementations, the second machine learning may be trained to extract a second type of content, different than the first type of content, from one or more input images.

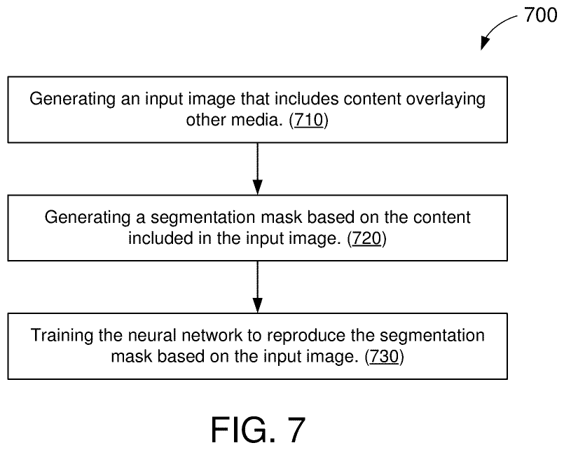

FIG. 7 shows an illustrative flowchart depicting an example operation 700 for training a neural network, according to some implementations. In some implementations, the example operation 700 may be performed by a machine learning system such as the machine learning system 400 of FIG. 4.

The machine learning system generates an input image that includes content overlaying other media (710). In some implementations, the content may include screen content. In some implementations, the content may include text, geometric shapes, or icons. The machine learning system generates a segmentation mask based on the content included in the input image (720). In some implementations, the segmentation mask may include the content and exclude the other media. In some implementations, the segmentation mask may be associated with an alpha channel of the input image. The machine learning system trains the neural network to reproduce the segmentation mask based on the input image (730).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of image compression, comprising:
receiving an image for transmission over a communication channel;
encoding the image as a first encoded image based on a first image compression scheme;
inferring a first segmentation mask from the image based on a first machine learning model;
inferring a second segmentation mask from the first encoded image based on the first machine learning model;
calculating a first visual fidelity metric for the first encoded image based on the first segmentation mask and the second segmentation mask; and
selectively transmitting the first encoded image over the communication channel based at least in part on the first visual fidelity metric.

2. The method of claim 1, wherein the first visual fidelity metric comprises a peak signal-to-noise ratio (PSNR), a PSNR based on properties of the human visual system (PSNR-HVS), a PSNR-HVS with visual masking (PSNR-HVS-M), a video multimethod assessment fusion (VMAF) metric, or a learned perceptual image patch similarity (LPIPS) metric.

3. The method of claim 1, further comprising:
encoding the image as a second encoded image based on a second image compression scheme different than the first image compression scheme;
inferring a third segmentation mask from the second encoded image based on the first machine learning model;
calculating a second visual fidelity metric for the second encoded image based on the first segmentation mask and the third segmentation mask; and
determining whether the first visual fidelity metric or the second visual fidelity metric indicates a higher image quality, the first encoded image being selectively transmitted over the communication channel based at least in part on whether the first visual fidelity metric or the second visual fidelity metric indicates a higher image quality.

4. The method of claim 3, wherein the selective transmitting of the first encoded image comprises:
refraining from transmitting the first encoded image over the communication channel responsive to determining that the second visual fidelity metric indicates a higher image quality.

5. The method of claim 3, further comprising:
transmitting the second encoded image, in lieu of the first encoded image, over the communication channel responsive to determining that the second visual fidelity metric indicates a higher image quality.

6. The method of claim 1, wherein the first machine learning model is trained to extract a first type of content from one or more input images.

7. The method of claim 6, wherein the first type of content comprises screen content.

8. The method of claim 6, wherein the first type of content includes text, geometric shapes, or icons.

9. The method of claim 6, further comprising:
inferring a third segmentation mask from the image based on a second machine learning model different than the first machine learning model;
inferring a fourth segmentation mask from the first encoded image based on the second machine learning model; and
calculating a second visual fidelity metric for the first encoded image based on the third segmentation mask and the fourth segmentation mask, the first encoded image being selectively transmitted over the communication channel based on the first visual fidelity metric and the second visual fidelity metric.

10. The method of claim 9, wherein the second machine learning is trained to extract a second type of content, different than the first type of content, from one or more input images.

11. An image encoder comprising:
a processing system; and
a memory storing instructions that, when executed by the processing system, causes the image encoder to:
receive an image for transmission over a communication channel;
encode the image as a first encoded image based on a first image compression scheme;
infer a first segmentation mask from the image based on a first machine learning model;
infer a second segmentation mask from the first encoded image based on the first machine learning model;
calculate a first visual fidelity metric for the first encoded image based on the first segmentation mask and the second segmentation mask; and
selectively transmit the first encoded image over the communication channel based at least in part on the first visual fidelity metric.

12. The image encoder of claim 11, wherein execution of the instructions further causes the image encoder to:
encode the image as a second encoded image based on a second image compression scheme different than the first image compression scheme;
infer a third segmentation mask from the second encoded image based on the first machine learning model;
calculate a second visual fidelity metric for the second encoded image based on the first segmentation mask and the third segmentation mask; and
determine whether the first visual fidelity metric or the second visual fidelity metric indicates a higher image quality, the first encoded image being selectively transmitted over the communication channel based at least in part on whether the first visual fidelity metric or the second visual fidelity metric indicates a higher image quality.

13. The image encoder of claim 11, wherein the first machine learning model is trained to extract a first type of content from one or more input images.

14. The image encoder of claim 13, wherein execution of the instructions further causes the image encoder to:
infer a third segmentation mask from the image based on a second machine learning model different than the first machine learning model;
infer a fourth segmentation mask from the first encoded image based on the second machine learning model; and
calculate a second visual fidelity metric for the first encoded image based on the third segmentation mask and the fourth segmentation mask, the first encoded image being selectively transmitted over the communication channel based on the first visual fidelity metric and the second visual fidelity metric.

15. The image encoder of claim 14, wherein the second machine learning is trained to extract a second type of content, different than the first type of content, from one or more input images.

16. A method of training a neural network, comprising:
generating an input image that includes content overlaying other media;
generating a segmentation mask based on the content included in the input image; and
training the neural network to reproduce the segmentation mask based on the input image.

17. The method of claim 16, wherein the content includes text, geometric shapes, or icons.

18. The method of claim 16, wherein the content comprises screen content.

19. The method of claim 16, wherein the segmentation mask includes the content and excludes the other media.

20. The method of claim 16, wherein the segmentation mask is associated with an alpha channel of the input image.
